(19) United States
(12) Patent Application Publication
(10) Pub. No.: US 2002/0150716 A1
(43) Pub. Date: Oct. 17, 2002

(54) Data storage media

(76) Inventors: Xiang Shui Miao, Singapore (SG); Tow Chong Chong, Singapore (SG); Lu Ping Shi, Singapore (SG); Pik Kee Tan, Singapore (SG)

Correspondence Address: Cooper & Dunham LLP, 1185 Avenue of the Americas, New York, NY, 10036, US

(21) Appl. No.: 09/882,391

(22) Filed: Jun. 15, 2001

(30) Foreign Application Priority Data
Apr. 17, 2001 (SG) 200102168-2

(51) Int. Cl. B32B 3/02

(52) U.S. Cl. 428/64.4

(57) ABSTRACT

In data-storage media such as rewritable optical discs (DVD−RAM, DVD+RW, DVD−RW, DVR, CD−RW and PD), the current need for the disc to be initialised before it can be used is eliminated. This is achieved by depositing on the disc, immediately before and/or after the record layer itself has been deposited, a layer of additional material that induces the record layer to become deposited in its crystalline state, or to be transformed spontaneously into that state. One specific material, which has this effect on record layers of GeSbTe and/or AgInSbTe, is Sb₂Te₃.

This invention relates to reducing the production time and cost of data-storage media, such as phase-change optical discs.

Electronic data can be written on, erased from, or overwritten many times on a rewritable optical disc, and preserved for long periods without change. Such media are widely used for data storage and backup, videos, movies, audio and multimedia. Two types of phase-change material are widely used as the record medium in rewritable optical discs (such as the DVD−RAM, DVD+RW, DVD−RW, DVR, CD−RW and PD). One such known material is in the form of a deposited film of GeSbTe, as disclosed in U.S. Pat. Nos. 4,670,345, 5,935,672, 5,194,363, and 5,233, 599. The other material is a similar deposited film of AgInSbTe, as disclosed in U.S. Pat. Nos. 5,418,030, 5,891,542, 5,637,372 and 5,637,371, and in JP 3-240 590 and 3-99 884. In order to meet the optical and thermal requirement of phase-change optical disc, a multi-layer structure was used for such discs, including layers of dielectric and reflective materials. It is known to use (ZnS)₈₀(SiO₂)₂₀ and Al alloy films (see U.S. Pat. Nos. 4,847,132, 5,191,565, 5,453,346, 5,665,520 and 6,004,646,) as the dielectric and reflective layers of phase-change optical discs.

A phase-change record medium in a rewritable disc has two phases, amorphous and crystalline phase, which both have different optical constants, hence the reflectivity of each phase or state is different. Recording is achieved by the crystallographic structure changes of thin films when exposed areas of the films are heated, as by focussed coherent radiation (laser beam). The amorphous state is realized by heating the film material with sufficient irradiation power to raise its temperature above its melting point, then rapidly quenching it to room temperature. The crystalline state is achieved by annealing the film at a temperature between the crystallizing temperature and the melting point. The information at the data storage positions is determined by detecting the difference of reflection of the two phases at each exposed area, which are read as either ‘0’ or ‘1’.

When a phase-change medium is deposited, it is usually in the amorphous state. It is preferable to crystallize the deposited films before recording. This crystallization process is called ‘initialization’. If the amorphous state is used as the background state of the phase-change material, the erasure of a bit by using an incident beam of radiation will leave a mark on the surface in the form of a ring, because of the Gaussian distribution of the energy of the laser beam. This means that the area of material used to record a ‘bit’ is not returned to its original state by later erasure or overwriting. Also, the reflectivity of areas of the deposited film in its amorphous state is different from those same areas after laser-quenching. Therefore, initialization is very necessary for the phase-change optical discs. Furthermore, this initialization process enables the reflectivity to be high enough for conventional focusing and tracking servos.

Some methods have been disclosed for initialising a phase-change optical disc, as in U.S. Pat. Nos. 5,557,599, 5,684,778, 5,646,930 and 5,875,160. These patents disclose using a laser beam. A light spot of from several tens to several hundreds μm wide is formed by means of a laser beam having a power output far greater than that of a laser diode used for writing and reading. By irradiating the layer with such a wide beam, and with the disc moving at a constant speed, many tracks can be crystallized in a single operation. This method has the advantage of small thermal load and unlikely crack damage, because the medium is heated only a small area at a time. This method has been widely used in the production of phase-change optical discs. Other methods to initialize such discs have also been proposed, such as using a flashing light (U.S. Pat. Nos. 6,060,221, and JP 63-261 533 and 62-250 533), or heating the disc to the crystallization temperature of the phase-change medium (JP-A98641, JP-A5246).

Most manufacturers have used a laser beam for initialization. However, the time required for the initialization process using a laser beam is significantly longer than for other manufacturing processes in the product line; the initialization equipment is very expensive, and several initializers are required in a production line. Thus the initialization process forms a bottleneck in the production of phase-change optical disc. In order to reduce the production time and the production cost in the product line, the initialization-free production of optical discs is essential for the production of DVD−RAM, DVD+RW, DVD−RW, DVR, CD−RW and PD optical discs. In order to make initialisation unnecessary, i.e. “Initialization-free”, it is necessary to ensure that the record layer as deposited is in its crystalline state. It has previously been proposed, in U.S. Pat. No. 5,627,012, to eliminate the initialization of AgInSbTe type phase-change material by the use of a new phase-change record material ABCDM (in which A=Ag or Au; B=Sb or Bi; C=Te or Se; D=In, InAl or InP, and M=Ti, Zr, Hf, V, Nb, Ta, Mn, W or Mo) and separating the step of sputtering of B (or B-D) base metal from the step of sputtering A-C base metal.

For rewritable phase-change discs, the data are detected by the difference in reflectivity of each datum-storage area according to its physical state, i.e. amorphous or crystallization. In conventional phase-change discs, before information is able to be recorded, the initialization process must be completed, therefore the production of ‘initialization-free’ discs means that the as-deposited disc has its data-recording layer(s) in its crystalline state already, having been crystallized during deposition.

This invention is based on the discovery of materials which can cause sputter-deposited phase-change media to be deposited in crystalline state during the deposition process.

Accordingly the present invention provides materials and methods as claimed in the appended claims for ensuring that as-deposited thin record films are crystalline.

Thin-film deposition by sputtering has the advantage of being suitable for all useful materials (including high melting-point element and compound), high adhesive force between film and substrate, high density of sputtered film, easy film thickness control, good reproduction and good uniformity over large areas. At present, phase-change record discs are generally deposited with direct-current (DC) and radio-frequency (RF) sputtering systems.

Sputtering entails the bombardment of a target with energetic particles (ions) which cause some surface atoms of the desired material to be ejected from the target. The ions are formed when a high electric field is applied to a low-pressure inert gas such as argon, creating a glow discharge in the deposition chamber. The positively-charged argon ions are accelerated through the field to strike a cathode, made of the material to be sputtered. Sputtering is caused by the direct transfer of momentum from the bombarding ions to the atoms of the target.

It is known that the temperature of the substrate on which the sputtered atoms are deposited will be increased during the sputtering process. However, the material of known substrates (such as polycarbonate) cannot withstand high temperatures (>120° C.) while the phase-change record layer is crystallized. This makes it impossible for the conventional phase-change disc to be crystallized during sputtering. In this invention, the use is disclosed of layers of suitable material that will also be deposited on the substrate by sputtering and which have the property of inducing the later- and/or prior-deposited record material to be deposited in crystalline state, or to be converted from amorphous to crystalline state without the addition of external energy. The additional layers may be in the form of two layers which sandwich the phase-change layer between them, or in the form of one layer which is deposited under or on the phase-change layer. The material of the or each additional layer must have a very high crystallization speed; shorter crystallization time, and very low crystallization temperature, so that the additional layer will be crystallized during the sputtering process because of the surface bombardment by high-energy ions. Therefore it can induce the crystallization of phase-change recording media during the sputtering deposition.

The material to be used as a crystallization-inducing material has to satisfy the following requirements:

1) High crystallization speed;

2) Low crystallization temperature;

3) Similar crystalline structure to phase-change media;

4) Lattice constants close to those of phase-change media:

5) No phase separation from phase-change media, and

6) Strong adhesion between the material and phase-change media.

In this invention, for the GeSbTe type and AgInSbTe type phase-change record media, an element or an alloy of at least Sb, Te, Sb—Te, Si, Pa, TI, Pb, Ga, In, Sn, Ge, As, Se, Al, Si, P, S, B, C or N is included in films to be used as the additional layer. For example, for GeSbTe phase-change media, GeTe-Sb₂Te₃ pseudo binary compositions may be used in one stoichiometric compound, as Sb₂Te₃ film evidently does not cause phase separation in the GeSbTe record layer. Also, the crystalline structure of Sb₂Te₃ film is rhombohedral (space group: R3m) and is the same as Ge₁ Sb₂ Te₄ film. The lattice constants of Sb₂Te₃ film (a=0.4262 nm, c=3.0458 nm) are very close to the lattice constants of Ge₁ Sb₂Te₄ film (a=0.421 nm, c=4.06 nm). Therefore Sb₂Te₃ film is more suitable than other films for the initialization-free deposition of Ge₁ Sb₂Te₄film. However, it is possible that other materials for the additional layer are suitable for other GeSbTe (such as Ge₂Sb₂Te₅, Ge₂Sb₂₊ₓ Te₅, Ge₁ Sb₄Te₇) and AgInSbTe phase-change media.

A conventional phase-change optical disc comprises a transparent substrate, two dielectric layers, a phase-change record layer, a reflective layer and a protective layer. The disc of this invention has any disc structure which comprises the phase-change layer(s) and includes at least one additional layer of material that causes the record layer to become crystallised spontaneously.

Accordingly the present invention provides a data-recording medium, and its method of manufacture, as claimed in the respective appended claims.

The present invention will now be described by way of example with reference to the accompanying drawings, in which:

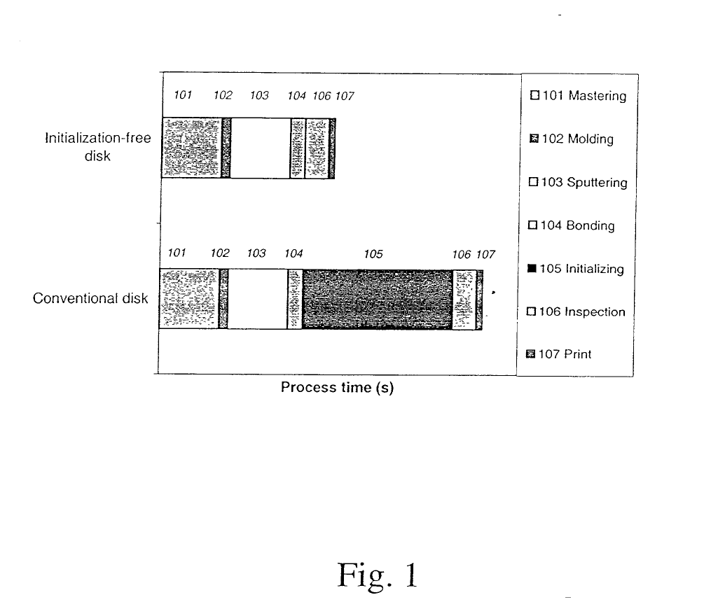

FIG. 1 is a diagram comparing the total production time of a known phase-change disc (CD) with that of a disc of this invention;

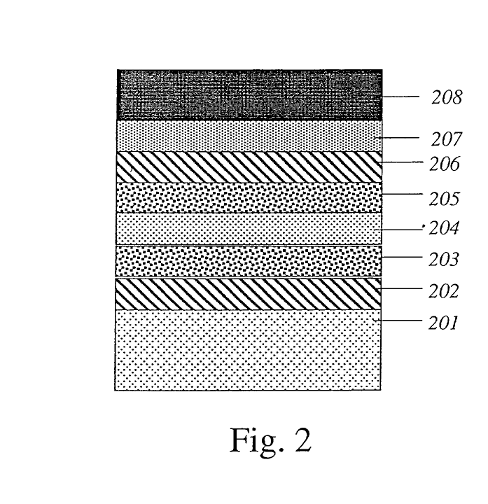

FIG. 2 is a cross-section of a disc of this invention, on a magnified scale;

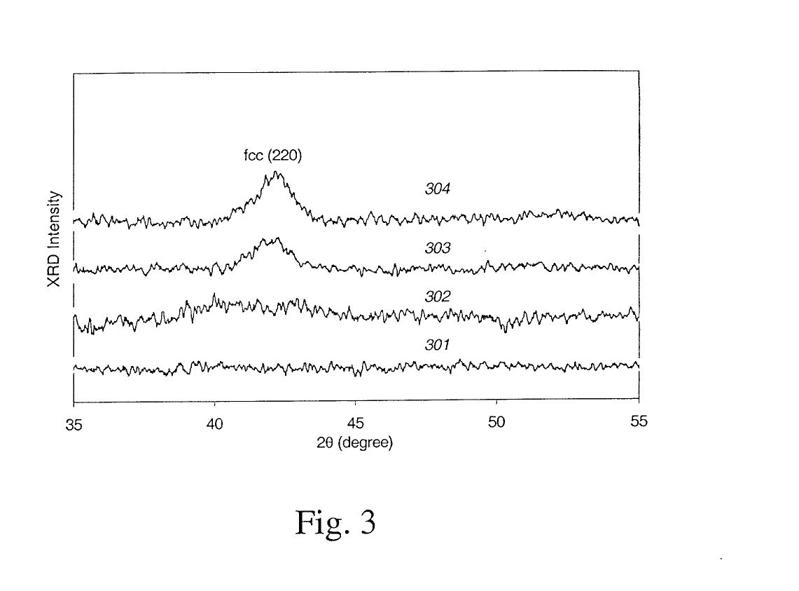

FIG. 3 is a graph of the X-ray diffraction patterns of different samples of record material, against 2θ;

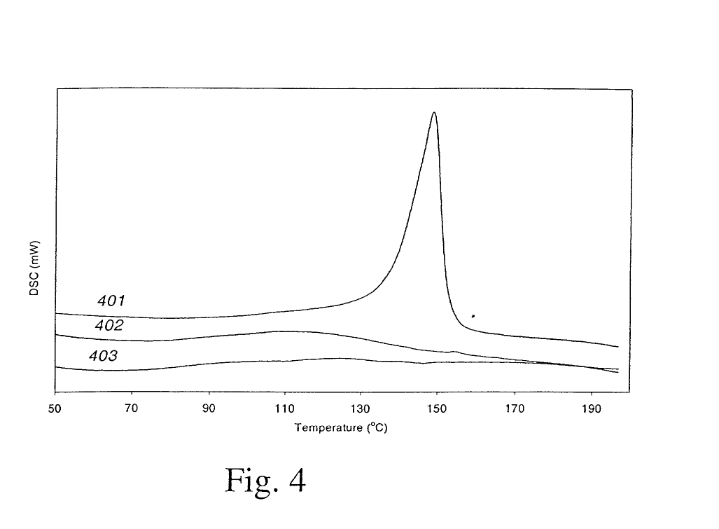

FIG. 4 is a graph of the energy output of different samples of record material, as obtained by a differential scanning calorimeter (DSC), against temperature;

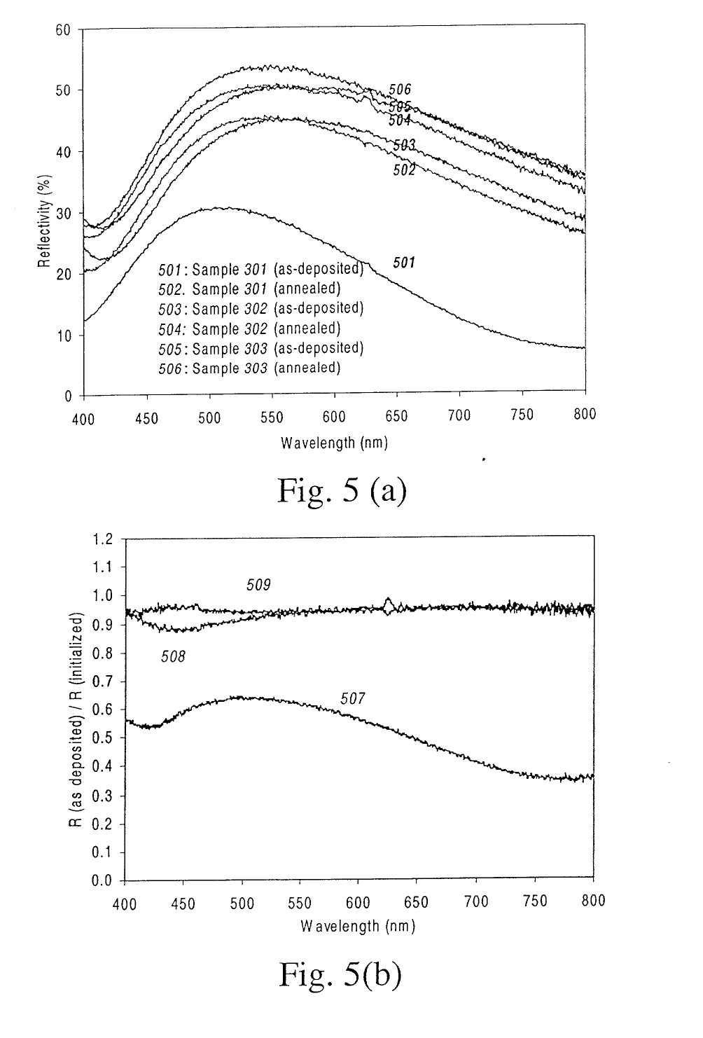

FIGS. 5(a) and 5(b) are graphs showing the variation of reflectivity with wavelength of different samples;

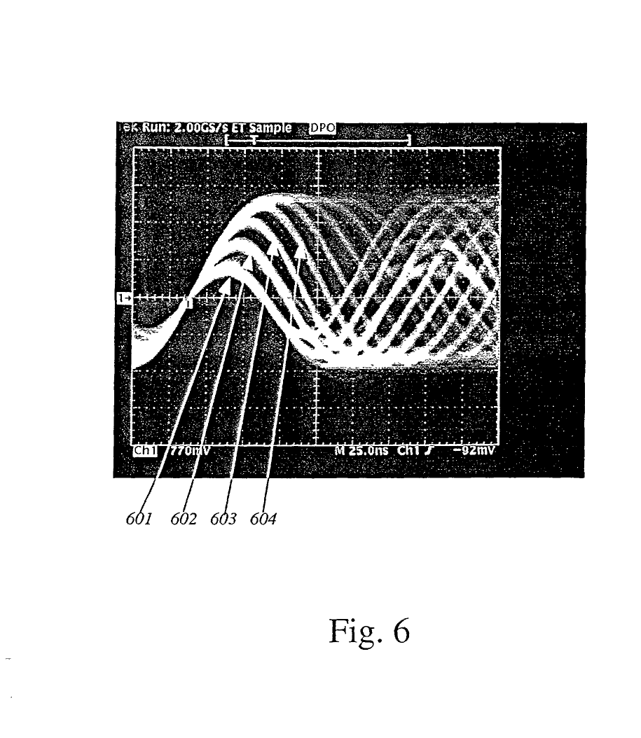

FIG. 6 is the eye-pattern of the invented disc;

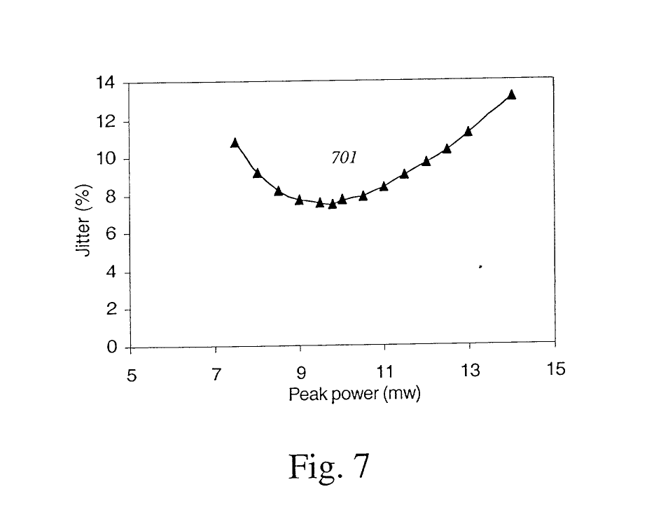

FIG. 7 is a curve demonstrating the jitter dependence of the disc of this invention on the writing power;

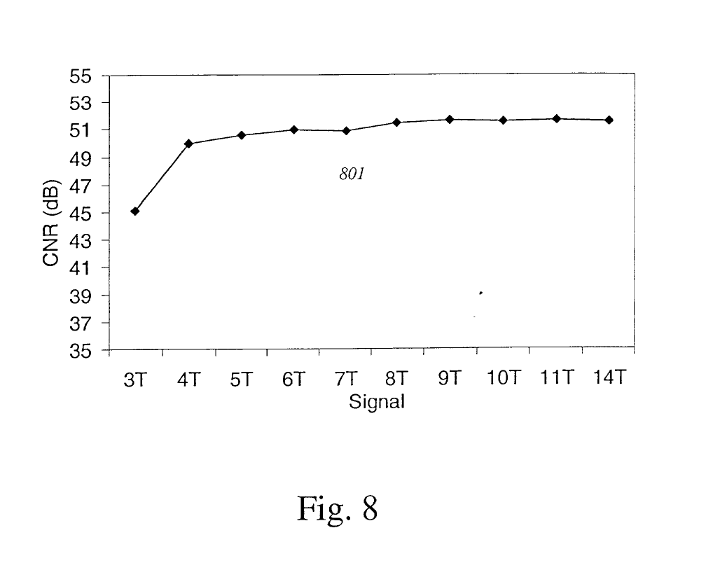

FIG. 8 is the CNR of the invented disc, and

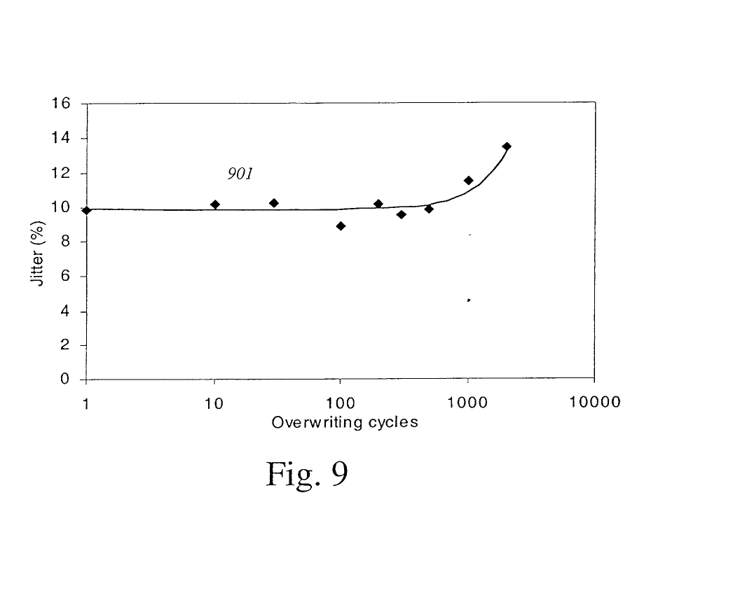

FIG. 9 is a curve showing the jitter dependence of the disc of this invention on the overwriting cycles.

In FIG. 1, the upper diagram is a simplified schematic view of product process time of rewritable phase-change optical disc of the present invention compared with a conventional known disc. In FIG. 1, the mastering process 101 includes the format encoding, photo-resist coating, laser beam recording (LBR), development of the photo-resist layer, metallizing with Ni, electroforming and stamper making. During the injection moulding process 102 precise grooves are moulded into a transparent disc substrate which carries pre-grooves from the stamper. It delivers 1.2 mm (CD) or 0.6 mm (DVD) substrates which have exceptionally high optical, mechanical and groove geometry characteristics. The sputtering process 103 is the key of a rewritable phase-change optical disc. It includes materials, disc structure design and disc deposition. For a digital video disc (DVD), the UV adhesive method, hot-melt bonding method, cationic bonding method can be used for the bonding process 104. The first method is considered as the most effective. The initializing process 105 changes the conventional record layer from its as-deposited amorphous state to the desired crystalline state. The inspection process 106 is to check on tilt and dishing measurements. The printing process 107 can only be used on the dummy surface of a single-sided disc or around the center hole of a double-sided disc. As shown in FIG. 1, it is clear that the overall production time is shortened greatly if the initializing step 105 can be omitted. Therefore, this invention will shorten the production time and reduce the product cost very greatly.

The disc of this invention has any structure that comprises phase-change record layer(s) and at least one additional layer of material that ensures that the record layer is transformed into its desired crystallised state without the need for initialization. The record layer may be sandwiched between two additional layers or vice versa.

FIG. 2 shows one example of a cross-sectional view of the disc of this invention. The disc comprises a substrate 201, which may be of transparent material, such as polycarbonate, glass or like. The substrate supports a first layer of dielectric material 202, a first additional layer 203, a phase-change data record layer 204, a second additional layer 205, which may be of the same material as layer 203 or of a different material, a second dielectric layer 206, a reflective layer 207 and a protective layer 208. The dielectric layers 202 and 206 sandwich the active layers (the record layer 204 and the additional layers 203 & 205) between them to protect them. When data are to be recorded on the disc, a beam of suitable radiation is focused on the record layer 204. The record layer 204 consists of a phase-change material of which the state of exposed areas can be switched by heating each area by a radiation beam between a state with an amorphous structure and a state with a crystalline structure. The film thicknesses of the disc of FIG. 2 are: dielectric layer 202, 50-250 nm; the additional layer 203, up to 20 nm; the recording layer 204, 5-30 nm; the additional layer 205, up to 20 nm; the dielectric layer 206, 10-70 nm, and the reflective layer 207, 50-300 nm.

The materials of the record layer 204 are of the GeSbTe type and AgInSbTe type films. The material of the or each additional layer (203 & 205) is an element consisting of, or an alloy containing, Sb, Te, Sb—Te, Bi, Po, TI, Pb, Ga, In, Sn, Ge, As, Se, Al, Si, P, S, B, C and/or N, in general, or Sb₂Te₃ in particular. In specific embodiments of the invention, the layers were deposited on polycarbonate substrates by a Balzers Cube sputtering system. The record layer 204, the additional layer 203 & 205 , and the reflective layer 207 of Al alloy, were sputtered using the DC (direct current) magnetron sputtering method. (ZnS)₈₀(SiO₂)₂₀ film was chosen as the material of the dielectric layers, and these layers 202 & 206 were sputtered by the RF (radio-frequency) sputtering method.

A description of initialization-free DVD-RAM discs embodying the present invention will now be given:

### EXAMPLE 1

The samples were fabricated for confirmation of the initialization-free properties of rewritable phase-change optical discs. These samples were deposited using a BPS Cube sputtering system. The Ge₁Sb₂Te₄/Sb₂Te₃ films were used in this example.

FIG. 3 shows the X-ray diffraction patterns of the as-deposited samples 301, 302 and 303. The x-ray diffraction data of the samples were collected by an X-ray diffractometer (Philips X′Pert-MRD) using Cu Kα radiation. Sample 301 is the as-deposited conventional phase-change disc, with Ge₁Sb₂Te₄ film as the phase-change record layer 204. The thickness of record layer 204 is 20 nm. Sample 302 is the as-deposited partially-crystallized disc with Ge₁Sb₂Te₄ and Sb₂Te₃ films as the phase-change record layer 204 and additional layers 203 & 205. The thickness of layers 203, 204 and 205 are 3 nm, 10 nm and 7 nm, respectively. Sample 303 is the as-deposited crystallized disc with Ge₁Sb₂Te₄ and Sb₂Te₃films as the record layer 204, and the additional layers 203 & 205. The thicknesses of layers 203, 204 and 205 is 5 nm, 10 nm and 5 nm, respectively. Sample 304 is the sample 301 after having been annealed. The diffraction peak of sample 303 (the fcc (220) peak) is similar to that of sample 304, and sample 304 is the annealed state of sample 301.

The differential scanning calorimeter (DSC) curves 401, 402 and 403 obtained for the as-deposited samples 301, 302 and 303 are shown in FIG. 4. The DSC heat curves of the samples were tested by a differential scanning calorimeter (Shimadzu DSC-50) system. The nitrogen (N₂) flow rate, heating rate and sample powder weight were 30 ml/min, 20° C./min, and 9 mg, respectively. No exothermic peaks were observed in the DSC curves (402 and 403) of samples 302 and 303. This indicates that no glass transition occurred in samples 302 and 303 during the heating process. Thus samples 302 and 303 were not in the amorphous state at the time they were heated.

FIG. 5(a) shows the reflectivity curves 501-506 of samples 301, 302 and 303 in the as-deposited and annealed states. The normalized reflectivity as-deposited state/annealed state curves 507, 508 and 509 of FIG. 5(b) show the samples 301, 302 and 303. The reflectivity of the samples was measured using a scanning spectrophotometer (Shimadzu). Generally, the crystalline state of the record layer of the samples exhibits a higher reflectivity than the amorphous state. It can be seen that the reflectivity changes of samples 302 and 303 were much less than that of the sample 301, and that sample 303 showed the least change, with the reflectivity of the as-deposited sample 303 being very close to that of the annealed sample. The reflectivity of the as-deposited samples increased and was close to the annealed state when the film thickness of the additional layer increased.

The above results reveal that the as-deposited sample 303 is in the crystalline state and was crystallized during the sputtering: this indicates that sample 303 is an initialization-unnecessary disc,

### EXAMPLE 2

In the initialization-unnecessary 4.7 GB DVD-RAM discs of this example, the disc layer structure and materials are same as sample 303. After the sputter deposition, the disc was bonded with Steag Hamatech DVD bonder. The dynamic properties of the disc were tested by Shibasoku LM330A DVD tester.

FIG. 6 shows the eye-pattern of the RF signal of the disc of this invention. This disc displays very clear eye-pattern. 601, 602, 603 and 604 is corresponding to the signal of 3T, 4T, 5T and 6T, respectively. The T (period of a channel bit) of a 4.7 GB DVD−RAM is 17.13 ns. The distinct eye pattern demonstrates that the frequency of each signal (3T-14T) can be accurately repeated. This will lead to low jitter and low error bit rates.

FIG. 7 shows the jitter dependence of the disc of this invention on the writing power. The minimum jitter (random signal) of curve 701 is 7.5% at 9.8 mW writing power.

FIG. 8 shows the CNR (signal-to-noise ratio) of the disc of this invention. The CNR curve 801 increases from 45.09 dB to 51.58 dB as the signal increases from 3T to 14T.

The influence of jitter of the disc on the overwriting cycles is shown in FIG. 9. The jitter curve 901 is about 10%. (The jitter would be better if the laser power levels and pulse shapes were optimized). No significant deterioration was observed in the disc after 1000 overwriting cycles compared with the conventional disc. Moreover, no significant decrease of the modulation amplitude after 1000 overwriting cycles was observed in the disc of this invention.

The dynamic results show no obvious difference was found between the as-deposited initialization-unnecessary disc of this invention and conventional discs after initialization.

1. A rewritable data-storage optical disc having on it a deposited layer of record material on which data are able to be recorded by exposed areas thereof having their reflectivity altered or not by a beam of incident radiation, the record layer being in contact with at least one additional layer of a material which induces the material of the record layer to be deposited in a crystalline state or which induces a prior-deposited record layer to be changed spontaneously into its crystalline state.

2. A data-storage optical disc as claimed in claim 1, in which the record layer is sandwiched between two additional layers of a crystallisation-inducing material, and in which the material of the induction layers may be the same as each other or different from each other.

3. The disc as claimed in claim 1 or 2, in which the material of the or each additional layer consists of, or includes, in elemental or alloy form, Sb, Te, Bi, Po, Ti, Pb, Ga, In, Sn, Ge, As, Se, Al, Si, P, S, B, C and/or N.

4. A medium as claimed in any preceding claim, in which the record layer consists of, or includes, GeSbTe and/or AgInSbTe.

5. A medium as claimed in claim 4, in which the record layer consists of, or includes, Ge₁Sb₂Te₄.

6. A medium as claimed in any preceding claim, in which the or each additional layer consists of, or includes, Sb₂Te₃.

7. A method of making data-storage media that use a layer of phase-change material in which to record data, including the steps of:
depositing a layer of dielectric material on a substrate;
depositing a layer of record material either on the dielectric layer or on a layer of additional material;
depositing on either the dielectric layer or the record layer, or both, a layer of additional material which has the effect of inducing the material of the record layer either to be deposited in its crystalline state or to be changed after deposition spontaneously into its crystalline state;
depositing, on either the record layer or a superposed additional layer, a layer of a dielectric material, and
depositing a layer of reflective material on either the dielectric layer or a layer of optical compensation material.

8. A method as claimed in claim 7, in which at least some of the deposited layers are deposited by a sputter-deposited process.
